(19) United States
(12) Patent Application Publication
(10) Pub. No.: US 2008/0071440 A1
(43) Pub. Date: Mar. 20, 2008

(54) Method and System of Power Management for a Vehicle Communication Interface

(76) Inventors: Kam Patel, Macomb Twp, MI (US); Dan Morris, Troy, MI (US); Dennis Essenmacher, Royal Oak, MI (US); Rich Graham, Twining, MI (US); Matt Roache, Madison Heights, MI (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 11/532,255

(22) Filed: Sep. 15, 2006

(51) Int. Cl. G01M 17/00

(52) U.S. Cl. 701/29

(57) ABSTRACT

A method and system of power management for a vehicle communication interface that provides a connection between a diagnostic tool and the vehicle is provided. Power for the vehicle communication interface may be provided by the vehicle or the diagnostic tool depending on the configuration of the interface and tool. The vehicle communication interface can detect a presence of vehicle power and operate in full power mode when the vehicle power is available. Alternatively, the vehicle communication interface can detect the absence of vehicle power, receive power from the diagnostic tool, and start out in low power mode. The interface can then request or negotiate via USB standards for additional power from the diagnostic tool.

### FIELD OF INVENTION

This application relates generally to test and diagnostic systems for machines or other operating equipment. More particularly, the application relates to a vehicle communication interface that enables a diagnostic tool to connect to a vehicle and perform problem-solving testing. While the application is described in the context of a vehicle diagnostic system and method, the principles of the present application are equally applicable for other servicing systems, as well as for various non-automotive apparatus.

### BACKGROUND

Automotive vehicles are becoming highly computerized products. Consequently, a number of different types of diagnostic tools have been used to assist in diagnosis and repair of fault conditions in automotive vehicles. Such diagnostic tools can typically be connected to an on-board computer (e.g., on-board engine control unit (ECU)) of a vehicle in order to download and analyze vehicle operational information from the on-board computer. For example, a diagnostic tool may obtain information about a vehicle's engine, transmission, mechanical systems, air conditioning systems, braking system, power system, or any other system.

A number of different types of diagnostic tools have been used, such as engine analyzers, which are designed to monitor a variety of operating conditions of an internal combustion engine, and scanners for downloading data from vehicle on-board computers. In addition, diagnostic tools may include laboratory-type tools like oscilloscopes, digital volt-Ohm meters (DVOM) and the like.

Any of these diagnostic tools may be used with a computer-based diagnostic platform that permits a fault-based drivability diagnosis of a vehicle. The platform may present a user with a menu of problems indicated, e.g., by symptoms or service codes, and the user selects those problems that are pertinent to the vehicle under test. Based upon the selected faults, the system then presents the user with a list of tests to be performed to diagnose the cause or causes of the faults. The tests can be listed in the order in which they would most likely be effective in diagnosing the vehicle faults, based upon manufacturer's information and previous repair and diagnosis experience with this type of vehicle, for example.

Unfortunately, however, some on-board vehicle computer modules of a vehicle cannot connect directly to some diagnostic tools. For example, some modules on vehicles do not have typical serial or parallel ports to connect to the diagnostic tools. Thus, a communication interface is used that connects the diagnostic tool to the vehicle and acts as a communication network between the tool and vehicle. Power for the communication interface is usually supplied from the vehicle battery (12 volt battery), however when the communication interface is not connected to a vehicle, another power source is needed.

### SUMMARY

Exemplary embodiments describe a power management technique for a vehicle communication interface. In one aspect, the exemplary embodiments include a vehicle communication interface that comprises an interface and a processor. The interface connects a diagnostic tool to a vehicle for diagnosing faults in the vehicle. The processor detects a presence of power from a battery in the vehicle and responsively powers the vehicle communication interface from the battery in the vehicle and operates the vehicle communication interface in full-power mode. The processor also may detect the absence of the power from the battery in the vehicle and responsively power the vehicle communication interface from the diagnostic tool and operate the vehicle communication interface in low-power mode.

In another aspect, the exemplary embodiments include a system for diagnosing faults in a vehicle under test. The system includes a diagnostics tool for diagnosing faults in the vehicle, and a vehicle communication interface for connecting the diagnostics tool and the vehicle. The vehicle communication interface is powered by the vehicle under test, the diagnostics tool or both and selects to receive power from the vehicle if available and if not, receives power from the diagnostics tool.

In yet another aspect, the exemplary embodiments include a method of powering a vehicle communication interface that connects a diagnostic tool to a vehicle for diagnosing faults in the vehicle. The method includes detecting a presence of power at the vehicle communication interface, and if the power is from the vehicle, powering the vehicle communication interface from the vehicle and operating the vehicle communication interface in full-power mode. The method also includes if the power is from the diagnostics tool, powering the vehicle communication interface from the diagnostic tool and operating the vehicle communication interface in low-power mode. The method further includes if the power is from both the vehicle and the diagnostics tool, powering the vehicle communication interface from the vehicle and operating the vehicle communication interface in full-power mode.

These as well as other features, advantages and alternatives will become apparent to those of ordinary skill in the art by reading the following detailed description, with appropriate reference to the accompanying drawings.

### BRIEF DESCRIPTION OF FIGURES

FIG. 1 is a block diagram of an exemplary system using a diagnostic information portal to provide enhanced vehicle diagnostics.

FIG. 2 is a block diagram illustrating an example connection between a diagnostic tool and a vehicle for providing enhanced vehicle diagnostics.

FIG. 3 is a block diagram illustrating an example of a vehicle communication interface that requests power from the diagnostic tool, vehicle, or both.

FIG. 4 is one example of a flowchart depicting functional blocks of a method for providing power to a vehicle communication interface that is positioned between a diagnostic tool and a vehicle under test by the diagnostic tool.

### DETAILED DESCRIPTION OF EXEMPLARY EMBODIMENTS

Computerized diagnostic systems are becoming pervasive in several industries. This is true of the automotive industry, in which computers are increasingly relied upon for the running, maintenance, and repair of motor vehicles. Computerized diagnostic systems rely upon external and internal computers to assist technicians in diagnosing problems with vehicles, such as to receive, analyze, and provide data feedback to and from computers in vehicles to better diagnose problems.

The present application describes a power management technique for a vehicle communication interface that provides a connection between a diagnostic tool and the vehicle. Power for the vehicle communication interface may be provided by the vehicle or the diagnostic tool depending on the configuration of the interface and tool.

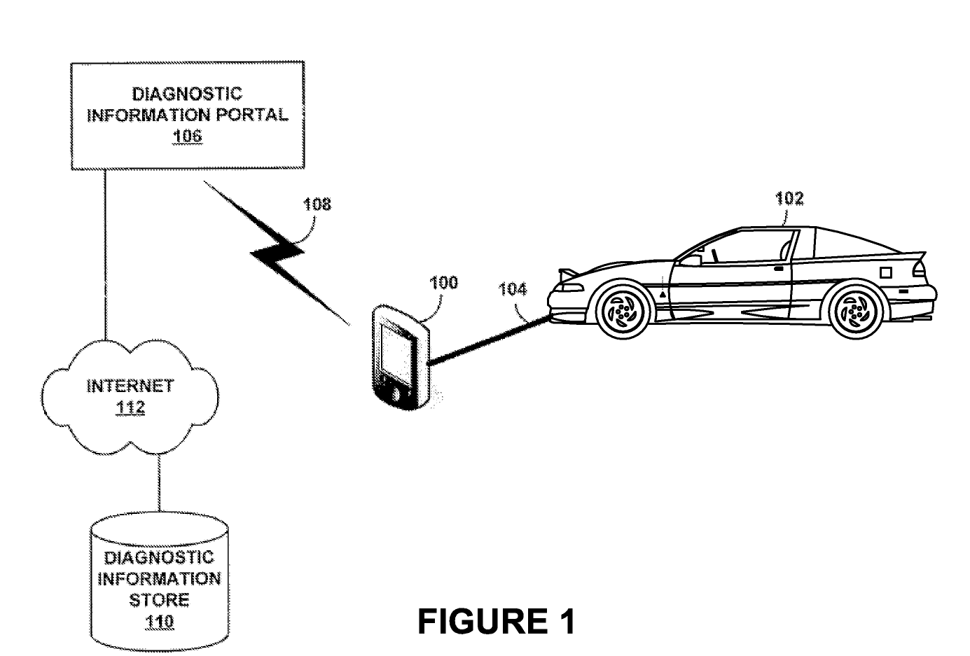

Referring now to the figures, FIG. 1 is a block diagram of an exemplary system using a diagnostic information portal to provide enhanced vehicle diagnostics. As illustrated, a diagnostic tool 100 interfaces with a vehicle 102 via a wired or wireless connection 104. The diagnostic tool 100 may be various types of devices used by a vehicle repair technician. For example, the diagnostic tool 100 may comprise a personal digital assistant (PDA) or other handheld device. Alternatively, the diagnostic tool 100 may comprise a desktop computer, a laptop computer or some other type of diagnostic equipment. One example of a diagnostic tool includes a vehicle analyzer system, such as the engine analyzer system disclosed in U.S. Pat. No. 5,250,935, which is herein incorporated in its entirety by reference, as if fully set forth in this description.

The connection 104 may be a wired or wireless connection. For example, the diagnostic tool 100 may communicate using the Bluetooth standard with the vehicle 102. The diagnostic tool 100 interfaces with the vehicle 102 to collect diagnostic information about the vehicle 102. The information can come from sensor values, switch states or trouble codes, for example. The information is often in the form of diagnostic trees, which are created by the Original Equipment Manufacturer (OEM) of the vehicle. For example, a number of outside vendors, e.g., Original Equipment Managers (OEM), exist from which car manufacturers buy many of their parts. OEMs provide flowcharts or diagnostic trees indicating instructions to diagnose a fault experienced by automotive vehicles. Thus, the diagnostic trees can be used to diagnose a problem with the vehicle 102. Diagnostic vehicle information may specifically include information relating to faults that may be experienced by a vehicle under diagnosis, tests that may be performed on the vehicle for the purpose of diagnosing the cause of the faults, and/or a solution that may be used to correct the faults. Although FIG. 1 depicts the vehicle 102 as a car, the principles discussed herein are applicable to many types of vehicles. The principles are also applicable to non-vehicles, such as machinery, industrial equipment or other objects that might need to be diagnosed and repaired.

The diagnostic tool 100 may interface with one or more systems within the vehicle 102 to obtain diagnostic information about those systems. For example, the diagnostic tool 100 might obtain information about the vehicle's engine, transmission, electrical systems, air conditioning system, braking system, power steering system or any other systems. The diagnostic tool 100 might interface directly with these various systems, as is illustrated in FIG. 1. Alternatively, the diagnostic tool 100 might interface with other diagnostic equipment (not shown), which in turn interfaces with various systems or components in the vehicle 102. Other configurations are also possible.

Depending on the vehicle 102 and the particular configuration of the diagnostic tool 100 or other equipment, the diagnostic tool 100 may automatically obtain information about the various systems in the vehicle 102. That is, the diagnostic tool 100 might obtain this information automatically upon being connected to the vehicle 102 or upon an appropriate prompt from a user of the diagnostic tool 100. An automated process such as this allows a vehicle repair technician to quickly and efficiently obtain diagnostic information about various systems in the vehicle 102.

The vehicle repair technician might also manually direct the diagnostic tool 100 to perform various tests on the vehicle 102 or to acquire certain other diagnostic information about the vehicle 102. This might be in addition to or in place of the previously described automated diagnostic information collection methods. Thus, the diagnostic tool 100 might automatically collect predetermined data, might collect additional data as directed by the vehicle repair technician, or might perform a combination of these methods to acquire the diagnostic information.

Once the diagnostic tool 100 acquires diagnostic information from the vehicle 102 and additional information if any is entered by the vehicle repair technician, the diagnostic tool 100 may then formulate a request to a diagnostic information portal 106. The diagnostic information portal 106 can provide a centralized location for vehicle repair technicians, through the use of diagnostic tools, to submit diagnostic information and in return to obtain possible causes of problems with their vehicles. The diagnostic information portal 106 can be located at the vehicle repair technician's worksite and be used by multiple vehicle repair technicians at that worksite. Alternatively, the diagnostic information portal 106 can be located at a more central location and might then be accessed by vehicle repair technicians a multiple different worksites. Thus the diagnostic information portal 106 might communicate with multiple diagnostic tools, although FIG. 1 illustrates only a single such device.

The diagnostic tool 100 preferably communicates with the diagnostic information portal 106 over a wireless communication link 108; however, a wired link or a combination of wired and wireless links might alternatively be used. The diagnostic information portal 106 receives the request from the diagnostic tool 100. In response, the diagnostic information portal 106 uses the diagnostic information in the request to search various information sources to determine possible causes for the problem. The diagnostic information portal 106 might itself store these various information sources, such as OEM diagnostic trees, proprietary third party repair procedures, publicly available documentation (e.g., recall notices) or any other information sources than can be used to diagnose problems with the vehicle 102. Alternatively, one or more of the information sources might be stored remotely from the diagnostic information portal 106 in a diagnostic information store 110, which can be accessed by the diagnostic information portal 106 via one or more data networks 112 (e.g., a intranet, a LAN, a WAN, the Internet, etc. . . . ).

Once the diagnostic information portal 106 accesses the information sources to determine the possible causes of the problem, the diagnostic information portal 106 can then send a list or other description of the possible causes back to the diagnostic tool 100. The diagnostic tool 100 can in turn display the possible causes of the problem to the vehicle repair technician. Before sending the possible causes back to the diagnostic tool 100, the diagnostic information portal 106 might statistically prioritize the possible causes, so as to alert the vehicle repair technician to the more likely causes of the problem. This may aid the vehicle repair technician in more quickly diagnosing and fixing the problem with the vehicle 102.

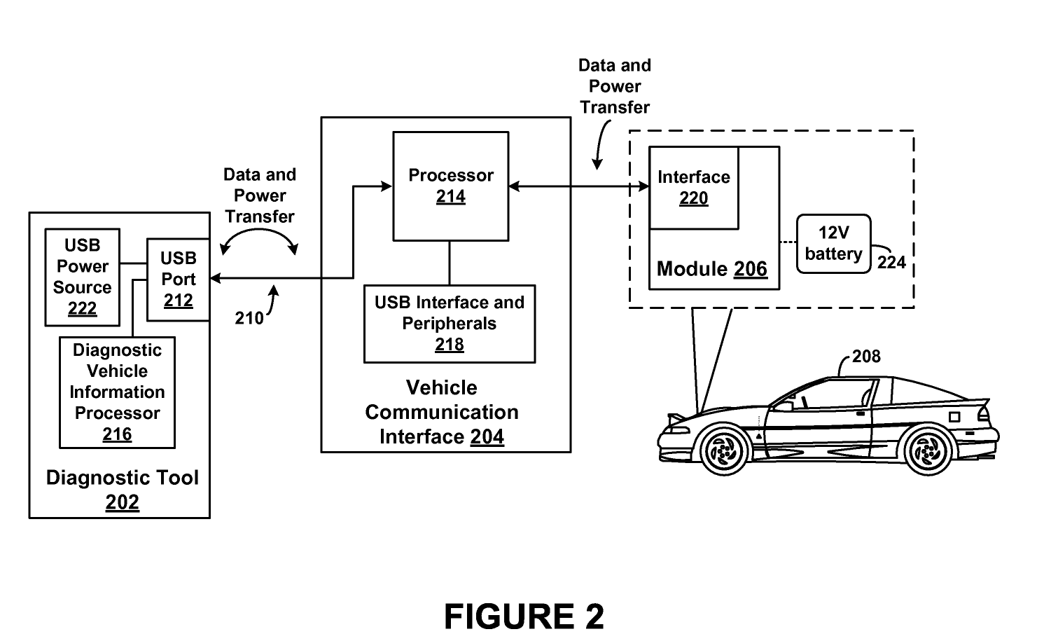

FIG. 2 is a block diagram illustrating an example connection between a diagnostic tool and a vehicle for providing enhanced vehicle diagnostics. As shown, a diagnostic tool 202 connects through a vehicle communication interface 204 to a module 206 of a vehicle 208. The diagnostic tool 202 physically connects to the vehicle communication interface 204 through a Universal Serial Bus (USB) cable 210 that connects to a USB port 212 of the diagnostic tool 202. The USB cable 210, in turn, connects to a processor 214 of the vehicle communication interface 204. Note that the vehicle communication interface 204 itself may be in the form of a USB power cable that includes intelligence described below. Alternatively, the USB cable 210 and the vehicle communication interface 204 may be separate entities that connect through other cables. Still alternatively, the vehicle communication interface 204 may connect to the diagnostic tool 202 and enable the diagnostic tool 202 to communicate wirelessly with the vehicle 208 (or the vehicle communication interface 204 may connect to the vehicle 208 and enable the vehicle 208 to communicate wirelessly with the diagnostic tool 202). In this instance, the diagnostic tool 202, the vehicle communication interface 204, and the vehicle 208 each include wireless receivers/transmitters as needed.

The diagnostic tool 202 will receive information at a diagnostic vehicle information processor 216 from USB interface and peripheral controls 218 of the vehicle communication interface 204. Conversely, the diagnostic tool 202 can send information through the vehicle communication interface 204 to a communications port or interface 220 of the vehicle module 206 of the vehicle 208. The vehicle communication interface 204 can send information to the module 206 through a USB cable, or other customized cable (e.g., not USB based).

The vehicle communication interface 204 does not have an independent power source, and thus, receives power from a USB power source 222 of the diagnostic tool 202, a battery 224 of the vehicle 206, or both. Power may usually be provided from the vehicle's battery 224. However, when the vehicle communication interface 204 is not connected to the vehicle 208, but only to the diagnostic tool 202, then power is provided by the diagnostic tool 202. For example, at times, program memory (not shown) of the vehicle communication interface 204 may need to be updated, so the vehicle communication interface 204 can be connected to the diagnostic tool 202 for the updates, and at that time will be powered by the diagnostic tool 202 as well.

As shown in FIG. 2, the USB port 212 of the diagnostic tool 202 is powered by the USB power source 222. The USB port 212 and the USB power source 222 operate according to the Universal Serial Bus Specification, Revision 1.1, Released Sep. 23, 1998 or the Universal Serial Bus Specification, Revision 2.0, Released Apr. 27, 2000, both of which are incorporated herein by reference as if fully set forth in this description.

The USB Specifications explain that a USB device, such as the vehicle communication interface 204, can receive power over a USB cable, such as cable 210. The cable 210 can transfer both power and data between the diagnostic tool 202 and the vehicle communication interface 204. The USB cable may include a single wire from which the vehicle communication interface 204 may draw power.

The USB specifications explain that the USB power source 222 usually can provide no more than 5.25 V and no less than 4.375 V. Initially, such as at power up, a USB device is typically only allowed to draw 100 mA. The device may request more current from the USB power source 222 in units of 100 mA up to a maximum of 500 mA. However, the USB power source 222 may deliver the full 500 mA or more to the vehicle communication device 204, even without a request. In addition, the USB specifications explain that a USB device may be either low-power at one unit load (100 mA) or high-power, consuming up to five unit loads, and that all devices default to low-power.

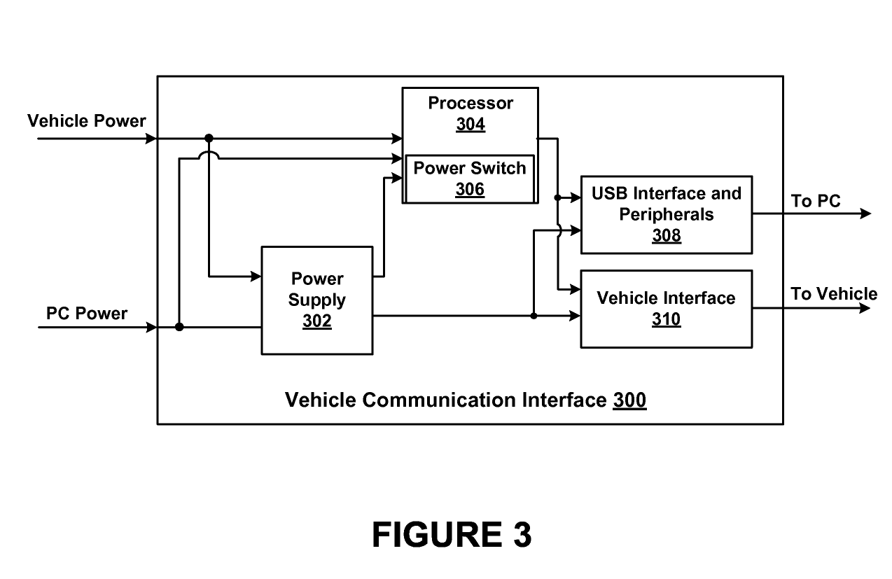

FIG. 3 is a block diagram illustrating an example of a vehicle communication interface 300 that requests power from the diagnostic tool, the vehicle, or both. The interface 300 includes a power supply 302, a processor 304 including a power switch 306, a USB interface and other peripherals 308, and a vehicle interface 310. The power supply 302 will receive power from the vehicle, the diagnostic tool or PC, or both. The vehicle is typically powered by a 12V battery, while the PC power will be supplied by a 5V USB power source. Thus, it may be preferable to receive power from the vehicle, since more power can be supplied.

To determine the source from which to seek power, the processor 304 samples the power sources. For example, upon power up of the vehicle communication interface 300, if the sole power source is the PC, the processor 304 may place all unused circuits (e.g., any of the peripherals 308) into a “Low Power” mode to minimize current draw from the PC. The USB specification dictates that any USB device can draw no more than 100 mA of current until the device negotiates for more. Thus, initially, the power supply 302 may receive 100 mA of current from the PC. Once negotiation is complete, and more power is provided (such as 500 mA or more if non-USB specification procedures are implemented), the processor 304 can place all of the USB interface and peripherals 308 in “Normal” operation mode.

The sole power source may be the PC during a firmware update for the vehicle communication interface 300 because at that time, the vehicle communication interface 300 may not be connected to the vehicle.

At power up, if the processor 304 determines that the sole power source is from the vehicle under test, the processor 304 does not need to place circuitry into “Low Power” mode. Rather, the processor 304 may begin communication to perform vehicle testing. The vehicle is typically powered by a 12V battery, and thus can provide the maximum amount of power needed by the vehicle communication interface 300. In this instance, once the vehicle communication interface 300 is connected to the diagnostic tool, the vehicle communication interface 300 will still perform a negotiation with the USB power source to obtain the maximum current required, to be properly prepared in the event that vehicle power is removed.

If at power up, the processor 304 determines that power is provided by both the vehicle under test and the PC, the processor 304 will draw power from the vehicle under test and begin communication to perform vehicle testing. In this instance, the vehicle communication interface 300 will still perform a negotiation with the USB power source in the diagnostic tool to obtain the maximum current required, to be properly prepared in the event that vehicle power is removed. In the event that the vehicle power is removed, the power switch 306 will direct the power supply 302 to draw power from the PC.

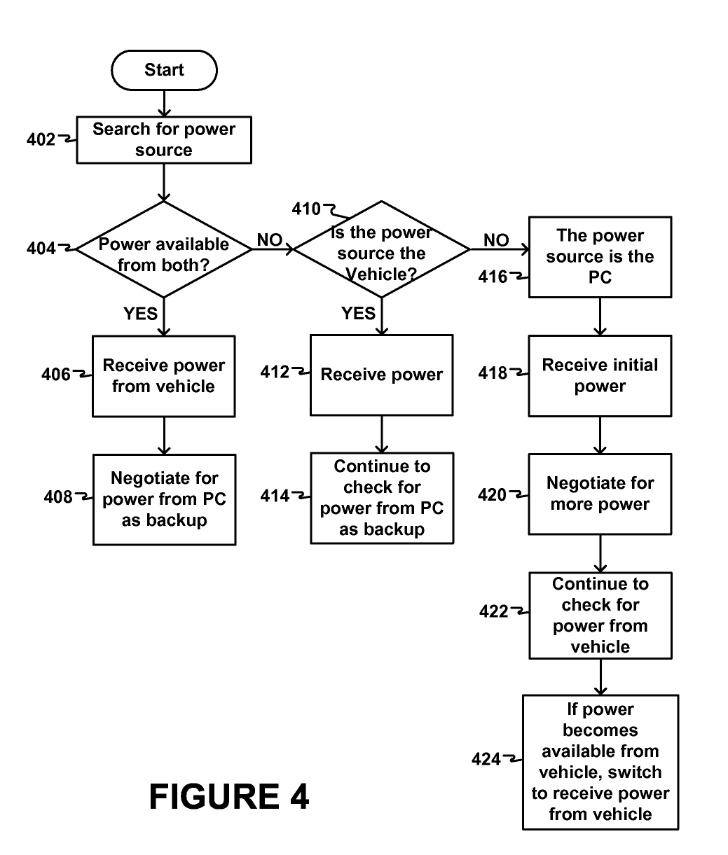

FIG. 4 is one example of a flowchart depicting functional blocks of a method for providing power to a vehicle communication interface that is positioned between a diagnostic tool and a vehicle under test by the diagnostic tool. Initially, at power up, the vehicle communication interface will search for a power source, as shown at block 402. To do so, the vehicle communication interface may use the procedures outlined in the USB Specifications (incorporated by reference above). For example, the interface will search for a signal on a power source pin of an input to the device. If there is no power signal, the interface will continue to monitor for a source, however, if there is a power signal the interface then determines the type of source.

If power is available from both the PC and the vehicle, as shown at block 404, the vehicle communication interface will select the vehicle as the preferred source of power and receive power from the vehicle, as shown at block 406. The vehicle communication interface will then negotiate with the PC to obtain power from the PC as a backup source, as shown at block 408. The vehicle communication interface will perform a standard USB power source negotiation with the PC as outlined in the USB Specification.

If power is not available from both the PC and the vehicle, but rather just the vehicle, as shown at block 410, the vehicle communication interface will receive power from the vehicle as shown at block 412. The vehicle communication interface will continue to check for power from the PC as a possible backup power source, as shown at block 414.

If power is not available from both the PC and the vehicle, but rather just the PC, as shown at block 416, the vehicle communication interface will receive the initial power (e.g., 100 mA) from the PC, as shown at block 418, and as outlined in the USB Specification. For example, the PC USB power source may only be able to provide minimal power to the vehicle communication interface initially; however, after a successful negotiation for more power, as shown at block 420, the vehicle communication interface may receive ample power to run the device. The vehicle communication interface will continue to check for power from the vehicle, as shown at block 422, and if power becomes available from the vehicle, the vehicle communication interface will switch to receive power from the vehicle, as shown at block 424.

As can be seen from the flowchart in FIG. 4, the vehicle communication interface may prefer to receive power from the vehicle, since the vehicle can provide more power and no negotiation process is necessary. Thus, the vehicle communication interface will continuously monitor the vehicle power supply circuit for activity. If active, then all subsequent power will be drawn from vehicle connection, and the USB power supply will be isolated. However, if the vehicle side power supply is determined to become inactive, then the vehicle communication interface will proceed to draw needed power from the USB power supply of the PC.

The method illustrated in FIG. 4 allows device power via the vehicle connection when available resulting in higher available power as necessary for diagnostic testing, and allows device power-up without a vehicle connection for lower power operations (e.g., device reprogramming).

When the vehicle communication interface is powered by the PC or diagnostics tool, the vehicle communication interface may operate in a low power mode with many of peripheral circuits shut-down, since the diagnostics tool may only be able to provide up to 500 mA of power from a USB power source. However, if vehicle power is available, the vehicle communication interface can operate in a full power mode.

Thus, within exemplary embodiments, the vehicle communication interface has the ability to detect a presence of vehicle power and operate in full power mode if available. Alternatively, the vehicle communication interface can detect the absence of vehicle power and start out in low power mode and request or negotiate via USB standards for additional power from the diagnostic tools. Upon receiving additional power, the vehicle communication interface can then enable other circuits for more operation.

The embodiments described herein may include or be utilized with any appropriate voltage or current source, such as a battery, an alternator, a fuel cell, and the like, providing any appropriate current and/or voltage, such as about 12 Volts, about 42 Volts and the like.

In addition, the embodiments described herein may be used with any desired system or engine. Those systems or engines may comprise items utilizing fossil fuels, such as gasoline, natural gas, propane, ethanol and the like; electricity, such as that generated by battery, magneto, fuel cell, solar cell and the like; and wind and hybrids or combinations thereof Those systems or engines may be incorporated into other systems, such as an automobile, a truck, a boat or ship, a motorcycle, a generator, an airplane and the like.

While examples have been described in conjunction with present embodiments of the application, persons of skill in the art will appreciate that variations may be made without departure from the scope and spirit of the application. For example, the apparatus and methods described herein may be implemented in hardware, software, or a combination, such as a general purpose or dedicated processor running a software application through volatile or non-volatile memory. The true scope and spirit of the application is defined by the appended claims, which may be interpreted in light of the foregoing.

1. A vehicle communication interface comprising:
an interface for connecting a diagnostic tool to a vehicle for diagnosing faults in the vehicle; and
a processor for detecting a presence of power from a battery in the vehicle and responsively powering the vehicle communication interface from the battery in the vehicle and operating the vehicle communication interface in a full-power mode, and for detecting the absence of the power from the battery in the vehicle and responsively powering the vehicle communication interface from the diagnostic tool and operating the vehicle communication interface in a low-power mode.

2. The vehicle communication interface of claim 1, wherein the processor powers the vehicle communication interface from a Universal Serial Bus (USB) power source in the diagnostic tool.

3. The vehicle communication interface of claim 1, wherein the interface includes a Universal Serial Bus (USB) connector.

4. A system for diagnosing faults in a vehicle under test, the system comprising:
a diagnostics tool for diagnosing faults in the vehicle; and
a vehicle communication interface for connecting the diagnostics tool and the vehicle, the vehicle communication interface being powered by the vehicle under test, the diagnostics tool or both, the vehicle communication interface selecting to receive power from the vehicle if available and if not, receiving power from the diagnostics tool.

5. The system of claim 4, wherein the vehicle communication interface wirelessly connects the diagnostics tool to the vehicle under test.

6. The system of claim 4, wherein the vehicle communication interface connects the diagnostics tool to the vehicle under test through a Universal Serial Bus (USB) cable.

7. The system of claim 4, wherein the diagnostics tool powers the vehicle communication interface using a Universal Serial Bus (USB) power source.

8. The system of claim 4, wherein if power from the vehicle is available, the vehicle communication interface receives power from the vehicle and operates in a high-power mode.

9. The system of claim 4, wherein if power from the vehicle is not available, the vehicle communication interface receives power from the diagnostics tool and operates in a low-power mode.

10. The system of claim 9, wherein the low-power mode includes power-up and reprogramming operations.

11-20. (canceled)
